(19) United States
(12) Patent Application Publication
(10) Pub. No.: US 2024/0262700 A1
(43) Pub. Date: Aug. 8, 2024

(54) SURFACE MODIFICATION OF MESOPOROUS ZEOLITE Y WITHOUT PORE BLOCKAGE

(71) Applicants: Chevron U.S.A. Inc., San Ramon, CA (US); The Regents of the University of California, Oakland, CA (US)

(72) Inventors: Alexander KATZ, Richmond, CA (US); Le XU, Berkeley, CA (US); Alexander OKRUT, San Francisco, CA (US); Alexander KUPERMAN, Richmond, CA (US)

(73) Assignees: Chevron U.S.A. Inc., San Ramon, CA (US); The Regents of the University of California, Oakland, CA (US)

(21) Appl. No.: 18/432,264

(22) Filed: Feb. 5, 2024

Related U.S. Application Data
(60) Provisional application No. 63/483,373, filed on Feb. 6, 2023.

(51) Int. Cl. C01B 39/02; B01J 29/08; B01J 37/02; B01J 37/08

(52) U.S. Cl. CPC C01B 39/026; B01J 29/084; B01J 37/0215; B01J 37/0236; B01J 37/08; B01J 2229/12; B01J 2229/32; C01P 2002/72; C01P 2004/03; C01P 2004/04; C01P 2006/17

(57) ABSTRACT

A selective postsynthetic surface modification process of mesoporous Y zeolite (Meso-Y) is provided. The process results in a thin silica, alumina or aluminosilicate overlayer on the external surface without causing significant pore blockage, which otherwise results in the absence of surfactant. The approach relies on occluded CTAB surfactant in as-synthesized Meso-Y acting as a soft template, which protects internal microporosity and mesoporosity during inorganic overlayer synthesis, by directing its deposition to selectively occur on the external surface. The process is conducted under dry conditions.

### CROSS-REFERENCE TO RELATED APPLICATIONS

The present application claims priority to U.S. provisional patent application 63/483,373 filed on Feb. 6, 2023, the disclosure of which is hereby incorporated by references in its entirety.

### BACKGROUND

Zeolites are a class of crystalline microporous materials that have been widely used as catalysts for the production of valuable chemical products, and zeolite Y in particular has been used for the fluid catalytic cracking (FCC) and hydrocracking of oil-derived molecules for decades. Although modern variants such as ultra-stable Y (USY) zeolite exhibit excellent performance in catalytic applications, one of the significant problems continues to be the severe diffusional limitations caused by the small micropores of zeolitic materials in general. In this regard, researchers have developed several postsynthetic methods to introduce intracrystalline mesoporosity into zeolites.

For instance, CBV-720 zeolite is a commercial USY zeolite (Si/Al=15) possessing FAU topology, and consists of irregular intracrystalline mesopores that are synthesized via steam treatment. This USY zeolite has been used as a starting material in previously reported surfactant-templating processes, which include hierarchical mesoporous Y zeolite (Meso-Y). The latter comprises a homogeneous distribution of intracrystalline mesopores and is typically synthesized by treating commercially available USY zeolite CBV-720 with an alkali hydroxide solution containing cetyl trimethylammonium bromide (CTAB) surfactant. Atomic-force microscopy (AFM) characterization data clearly demonstrate the formation of mesopores close to the external surface during surfactant templating. The resulting occluded surfactant is typically removed from the as-made material via combustion during calcination, to synthesize mesopores. The size of these generated mesopores is commensurate to those measured in the bulk by nitrogen physisorption and three-dimensional tomography based on transmission electron microscopy (TEM)—all resulting as a consequence of the CTAB surfactant assembly. These mesopores enable facile molecular transport, and act as a conduit for rapid diffusion of reactants and products to and from the catalytically active sites within the zeolitic material.

However, although hierarchical zeolitic structures have drawn much recent attention because of their improved transport properties, new challenges relating to surface diffusional barriers have been raised in these and related hierarchical mesoporous zeolite materials, which are responsible for increasing diffusional time constants. Such surface barriers are attributed to the large free energy differences between the gas/liquid phase, zeolite external surface, and the zeolite interior, and have been demonstrated by microimaging for a conventional Mordenite zeolite. To overcome these surface barriers, various postsynthetic surface modifications by chemical liquid and vapor deposition have been proposed.

An ongoing synthetic challenge in this regard is achieving spatially selective modification of the zeolite external surface with an inorganic-oxide (e.g., amorphous aluminosilicate) overlayer, without blocking zeolite interior porosity. Answering such a challenge can provide important applications in catalysis, as well as electrostatic adsorption.

### SUMMARY

Provided is a selective postsynthetic surface modification process of hierarchical mesoporous Y zeolite (Meso-Y), which results in a thin silica, alumina or aluminosilicate overlayer on the external surface without causing significant pore blockage, which otherwise results in the absence of surfactant. The approach relies on occluded CTAB surfactant in as-synthesized Meso-Y acting as a soft template, which protects internal microporosity and mesoporosity during inorganic overlayer synthesis, by directing its deposition to selectively occur on the external surface. It has been found important to conduct the surface modification under dry conditions at the stage of reacting oxide molecular precursors with the as-synthesized Meso-Y. If dry conditions are not employed, pore blockage and thicker silicate overlayers as well as phase separation for alumina overlayers occurs, which is observable via SEM. In contrast, under the present process, uniform silica/alumina nanoscale overlayers can be synthesized under dry conditions with no evidence of a separate phase, as demonstrated via TEM/SEM microscopy as well as Zeta-potential measurements. These uniform overlayers control the surface charge of Y zeolites, which can be crucial for applications involving adsorption and catalysis.

Among other factors, it has been found that a combination of CTAB surfactant and dry deposition conditions can successfully synthesize a uniform silica, alumina, or aluminosilicate shell on a mesoporous Y zeolite surface, while retaining mesoporosity and microporosity after coating. The presence of surfactant CTAB in the as-synthesized Meso-Y-as is important to achieve this selective modification of the Meso-Y-as zeolite external surface without pore blockage. This is achieved by a mechanism based on soft protection by the CTAB surfactant. Given the propensity for using inorganic-oxide surface-modified zeolites in functional applications, the resulting surface-modified zeolite materials are a promising new type of surface-modified zeolitic material for functional applications involving adsorption and catalysis, in which the surface charge (Zeta potential) of the surface can be precisely controlled.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1A shows powder X-ray patterns of as synthesized (as) silica-deposited samples obtained under wet conditions: (a) CBV-720, (b) Meso-Y-as, (c) Meso-Y-as@wet-4 wt. % SiO₂, (d) Meso-Y-as@wet-11 wt. % SiO₂.

FIG. 1B shows powder x-ray patterns of calcined silica-deposited samples obtained under wet conditions: (a) CBV-720 (b) Meso-Y-cal, (c) Meso-Y-cal@wet-4 wt. % SiO₂ and (d) Meso-Y-cal@wet-11 wt. % SiO₂

FIG. 2 shows SEM images of (a and b) CBV-720, (c) Meso-Y-as, (d) Meso-Y-as@wet-4 wt. % SiO₂, (e) Meso-Y-as@wet-11 wt. % SiO₂, (f) Meso-Y-cal and (g) Meso-Y-cal@wet-4 wt. % SiO₂ and (h) Meso-Y-cal@wet-11 wt. % SiO₂.

FIG. 3A shows N₂ adsorption-desorption isotherms of CBV-720, Meso-Y-cal, Meso-Y-cal@wet-4 wt. % SiO₂, and Meso-Y-cal@wet-11 wt. % SiO₂, and Meso-Y-as@wet-11 wt. % SiO₂.

FIG. 3B shows mesopore size distributions of CBV-720, Meso-Y-cal, Meso-Y-cal@wet-4 wt. % SiO₂, and Meso-Y-cal@wet-11 wt. % SiO₂.

FIG. 3C shows N₂ adsorption-desorption isotherms of CBV-720, Meso-Y-cal, Meso-Y-as@wet-4 wt. % SiO₂, and Meso-Y-as@wet-11 wt. % SiO₂.

FIG. 3D shows mesopore size distributions of CBV-720, Meso-Y-cal, Meso-Y-as@wet-4 wt. % SiO₂, and Meso-Y-as@wet-11 wt. % SiO₂.

FIG. 4 shows SEM images of (a) Meso-Y-as@wet-0.9 wt. % Al₂O₃, (b) Meso-Y-as@wet-2.2 wt. % Al₂O₃ and (c) Meso-Y-as@wet-4.6 wt. % Al₂O₃.

FIG. 5 shows powder X-ray patterns of silica-deposited samples obtained under dry conditions: (a) Meso-Y-as, (b) Meso-Y-as@dry-4 wt. % SiO₂, (c) Meso-Y-as@dry-11 wt. % SiO₂ and (d) Meso-Y-as@dry-15.4 wt. % SiO₂.

FIG. 6A shows N₂ adsorption-desorption isotherms of Meso-Y-cal, Meso-Y-as@dry-4 wt. % SiO₂, Meso-Y-as@dry-11 wt. % SiO₂ and Meso-Y-as@dry-15.4 wt. % SiO₂.

FIG. 6B shows mesopore size distributions of Meso-Y-cal, Meso-Y-as@dry-4 wt. % SiO₂, Meso-Y-as@dry-11 wt. % SiO₂ and Meso-Y-as@dry-15.4 wt. % SiO₂.

FIG. 7 shows SEM images of (a) Meso-Y-as@dry-4 wt. % SiO₂, (b) Meso-Y-as@dry-11 wt. % SiO₂ and (c) Meso-Y-as@dry-15.4 wt. % SiO₂.

FIG. 8 shows TEM images of (a, b) Meso-Y-cal, (c, d) Meso-Y-as@dry-11% SiO₂, (e, f) Meso-Y-as@dry-15.4% SiO₂, (g, h) Meso-Y-as@dry-2.2% Al₂O₃, (i, j) Meso-Y-as@dry-4.6% Al₂O₃.

FIG. 9 shows powder X-ray patterns of alumina-deposited samples obtained under the dry condition: (a) Meso-Y-as, (b) Meso-Y-as@dry-0.9 wt. % Al₂O₃, (c) Meso-Y-as@dry-2.2 wt. % Al₂O₃ and (d) Meso-Y-as@dry-4.6 wt. % Al₂O₃.

FIG. 10 shows SEM images of (a) Meso-Y-as@dry-0.9 wt. % Al₂O₃, (b) Meso-Y-as@dry-2.2 wt. % Al₂O₃ and (c) Meso-Y-as@dry-4.6 wt. % Al₂O₃.

FIG. 11A shows N₂ adsorption-desorption isotherms of Meso-Y-cal, Meso-Y-as@dry-0.9 wt. % Al₂O₃, Meso-Y-as@dry-2.2 wt. % Al₂O₃ and Meso-Y-as@dry-4.6 wt. % Al₂O₃.

FIG. 11B shows mesopore size distributions of Meso-Y-cal, Meso-Y-as@dry-0.9 wt. % Al₂O₃, Meso-Y-as@dry-2.2 wt. % Al₂O₃ and Meso-Y-as@dry-4.6 wt. % Al₂O₃.

FIG. 12A shows Zeta-potential change of the Meso-Y-cal with different silica loadings.

FIG. 12B shows Zeta-potential change of the Meso-Y-cal with different alumina loadings.

FIG. 13 is a schemed description of deposition processes of preparing Meso-Y-as under wet and dry conditions.

### DETAILED DESCRIPTION

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

Reference will now also be made in detail to exemplary aspects of the present disclosure that are illustrated in the accompanying drawings.

The present process utilizes a combination of CTAB surfactant and dry deposition conditions to successfully synthesize a uniform silica, alumina or aluminosilicate shell on a mesopores Y zeolite surface. The mesopores are generally within the size regime of >2 but <50 nm. This is accomplished while retaining mesoporosity and microporosity after the deposition of the coating.

The present process involves depositing a silica, alumina or aluminosilicate layer on a Meso-Y zeolite surface. The Meso-Y zeolite has been treated so that the mesopores of the Y zeolite contain CTAB surfactant. Such treatment can include any suitable, known treatment. For example, a suitable amount of CTAB surfactant can be dissolved in a basic aqueous solution. The solution is heated, and then the Y zeolite, e.g., CBV-270, is introduced into the solution. The solution is then kept at a suitable temperature, e.g., 90° C., for a length of time such as 5 or 6 hours while stirring. The resulting zeolite powder can be filtered, washed and dried to result in an as-synthesized Meso-Y-as material containing CTAB surfactant inside the newly formed mesopores. After calcination, e.g., at 580° C., a Meso-Y-cal material is obtained. It is preferred to sue the Meso-Y-as material for the process. After which calcination can occur. However, the process of depositing a silica, alumina, or aluminosilicate layer under dry conditions can also be used on Meso-Y-cal.

The Meso-Y-as zeolite material comprising the CTAB surfactant inside its mesopores is first dehydrated. The dehydration in one embodiment comprises heating the Meso-Y-as zeolite material under vacuum. In one embodiment, the heating under vacuum can comprise heating at a temperature in the range of 200-300° C., such as 250° C., under vacuum for 7-12 hours, in one embodiment 10 hours.

The dehydrated zeolite is then inserted into a reactor with a dry environment. The dry environment can be created by employing an inert gas atmosphere. In one embodiment, a nitrogen gas atmosphere is used.

Alumina, silica or aluminosilicate precursors are then mixed with a dry solvent to create a mixture. Any suitable solvent which does not pick up moisture can be used. In one embodiment, the solvent is tetrahydrofuran (THF). The solvent itself is also insured to be dry and free of water.

The process can involve any suitable alumina precursor should an alumina coating on the surface of the zeolite be desired. In one embodiment, the alumina precursor can be Al(O-i-Pr)₃. Should a silica coating be desired, then any suitable silica precursor can be used. In one embodiment, Si(OEt)₄ can be the silica precursor. If an aluminosilicate coating is desired, then both alumina and silica precursors are provided.

The mixture solution comprising the precursors is also inserted into the same reactor containing the dehydrated zeolite. The contents of the reactor are then refluxed to achieve a deposition reaction creating a layer of alumina, silica, or aluminosilicate on the surface of the Meso-Y-as zeolite. The refluxing generally occurs with stirring. The Meso-Y-as zeolite is recovered from the reactor and any remaining solvent is removed. The solvent can be removed by any suitable method. In one embodiment, the solvent is removed by evacuation. The Meso-Y-as zeolite recovered from the reactor can be calcined, either before or after removal of the solvent. In one embodiment, the calcination occurs after removal of the solvent. The calcination in one embodiment is at a temperature of about 580° C. for about 4 hours. The temperature and length can be varied.

In one embodiment, after removal of the solvent, the Meso-Y-as zeolite can be dried. In one embodiment, the drying can occur under vacuum. Calcination can then occur after the drying. In one embodiment, all calcinations occur in dry air.

The presence of the CTAB in the as-synthesized Meso-Y-as is important to achieve selective modification of the Meso-Y-as external surface without pore blockage. This is achieved by a mechanism based on soft protection by the CTAB surfactant. It has also been found important to employ dry deposition conditions as discussed above at the stage of reacting the oxide molecular precursors with the Meso-Y-as. If dry conditions are not employed, pore blockage and thicker silicate overlayers occur, as well as phase separation for alumina overlayers.

The following examples are provided to illustrate the present process and product, but are not intended to be limiting.

### Materials Synthesis

Preparation of Mesoporous zeolite Y (Meso-Y) based on the commercial Y zeolite.

CBV-720 was obtained from Zeolyst and ammonium ion exchanged prior to use. Synthesis of Meso-Y was conducted according to a previously reported surfactant templating approach. In a typical synthesis, 0.5 g of CTAB surfactant was dissolved in 20 mL of 0.09 M NaOH aqueous solution. The mixed solution was heated to 90° C. with an oil bath. After stirring for 30 min at 90° C., 1 g of CBV-720 was introduced and then kept at 90° C. for 6 h under stirring. The resulting zeolite powder was filtered, washed with deionized water, and dried at 80° C. for 12 h, resulting in the as-synthesized intermediate material Meso-Y-as, containing occluded CTAB surfactant inside the newly formed mesopores. After further calcination at 580° C. in air, the as-made hierarchical Meso-Y-cal was obtained.

Deposition of silica on Meso-Y-cal and deposition of silica, alumina or aluminosilicate on Meso-Y-as.

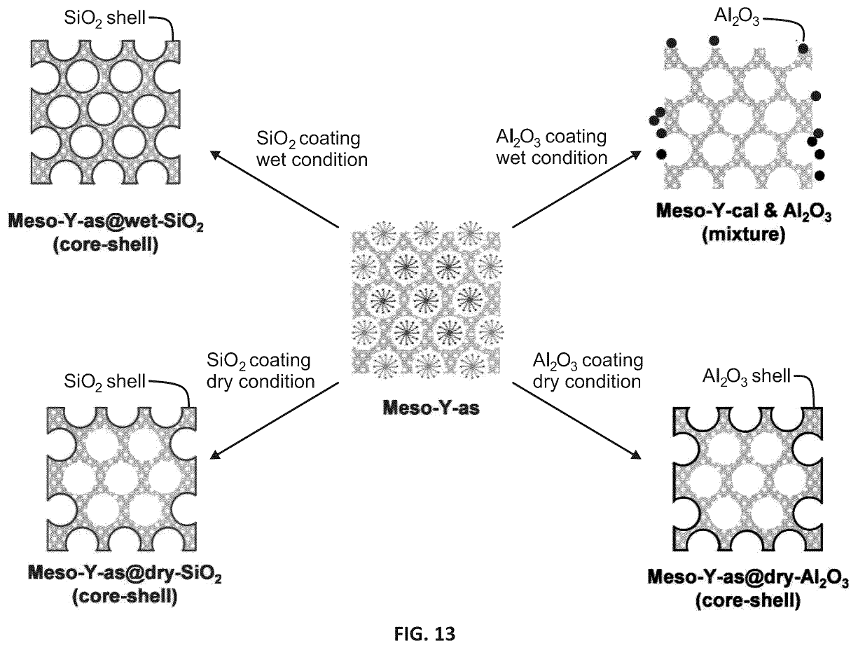

The deposition of silica, alumina or aluminosilicate overlayers was conducted on both Meso-Y-as and Meso-Y-cal, by using postsynthetic surface modification techniques. Two different kinds of deposition conditions were employed, corresponding to wet and dry conditions for comparison. See, for example, FIG. 13.

In a typical wet deposition, the entire procedure was conducted upon exposure to atomospheric moisture. 1 g of zeolite (Meso-Y-as or Meso-Y-cal) was dispersed in 25 mL of hexane. The desired amount of tetraethyl orthosilicate (TEOS) or aluminum isopropoxide (Al(O-i-Pr)₃) was introduced into the mixture, and the deposition was carried out for 1 h under reflux and stirring. Subsequently, hexane was removed by evacuation. The zeolite products were dried at 120° C. for 2 h under vacuum and calcined at 580° C. for 4 h in air. The final products were denoted as Meso-Y-as(Meso-Y-cal)@wet-x wt. % SiO₂ (or y wt. % Al₂O₃ at end), where x and y indicate the weight percentage of silica or alumina used for deposition, respectively. For example, for the product that was prepared from the Meso-Y-as with 4 wt. % SiO₂ deposition under wet condition, it was denoted as Meso-Y-as@wet-4 wt. % SiO₂.

The dry deposition experiments were performed under air-free conditions. For silica deposition, 1 g of the as-synthesized mesoporous zeolite (Meso-Y-as) was dehydrated at 250° C. under vacuum for 10 h to remove the residual water in the sample. After cooling down to room temperature, dry N₂ was injected into reactor as a protective gas and then 40 mL of dry tetrahydrofuran (THF) and TEOS were introduced into the reactor (the latter corresponding to a SiO₂ loading of 4-15.4 wt. %). The deposition was carried out under dry N₂ atmosphere under reflux and stirring for 1 h. After reaction, the THF solvent was removed by evacuation. The obtained samples were further dried at 120° C. for 2 h under vacuum and subsequently calcined in air or dry air at 580° C. for 4 h.

For alumina deposition, the desired amount of Al(O-i-Pr)₃ was introduced to a flask under Ar atmosphere in the glovebox (corresponding to a certain target weight percentage of Al₂O₃). Then dry THF solvent was mixed with Al(O-i-Pr)₃ at 60° C. under stirring (approximately 100 mL of THF was used per g of Al(O-i-Pr)₃). Sufficient THF solvent was used such that 80-90% of the Al(O-i-Pr)₃ was dissolved. The resulting solution containing Al(O-i-Pr)₃ was subjected to hot filtration under air-free conditions, to remove trace amounts of undissolved impurities. The filtrate was further mixed with the dry zeolite (Meso-Y-as). The mixture was allowed to react under N₂ atmosphere under reflux and stirring for 1 h. After reaction, the THF solvent was removed by evacuation. The samples were dried at 120° C. for 2 h under vacuum and further calcined in air or dry air at 580° C. for 4 h. The obtained sample was denoted as Meso-Y-as@dry-x wt. % SiO₂ or (y wt. % Al₂O₃ at end), where x and y were referred to as the weight percentage of deposited silica or alumina in the product, respectively. The deposition of an aluminosilicate overlayer is similar to that for the alumina deposition, except that a silica precursor is also introduced. Thus, both alumina and silica precursors are present.

### Characterization

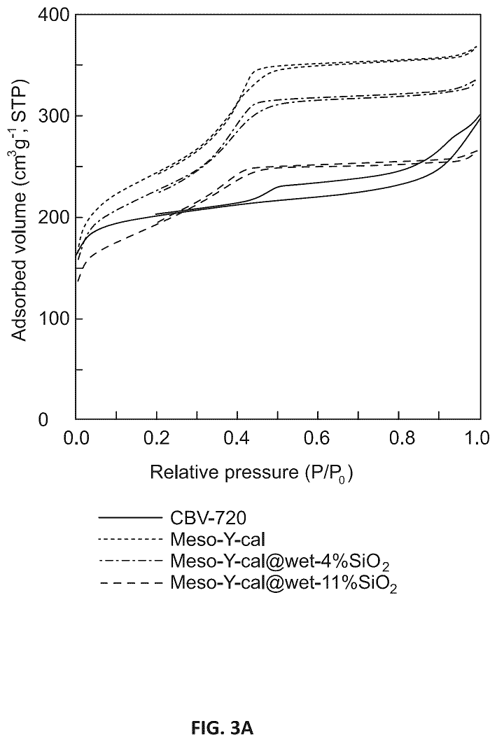

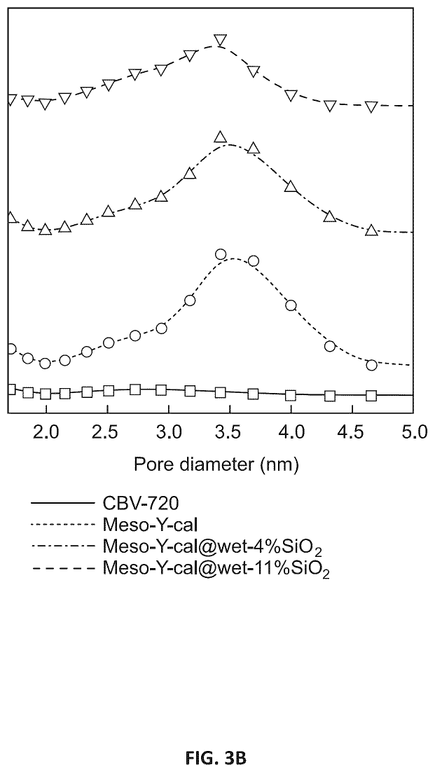

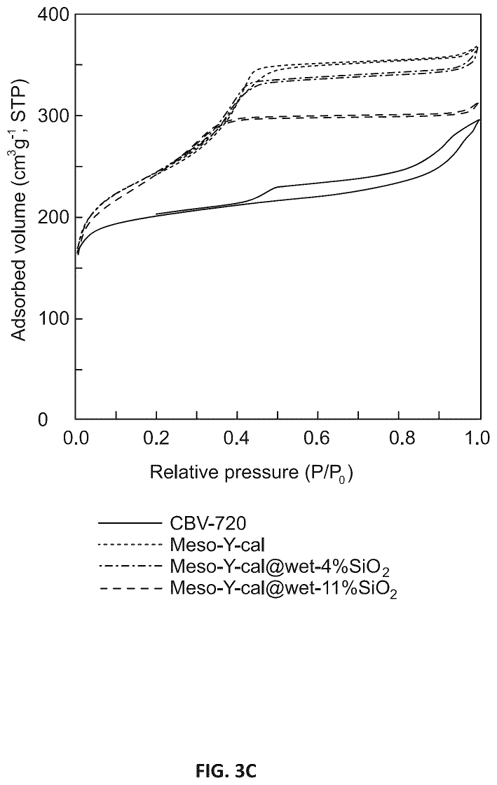

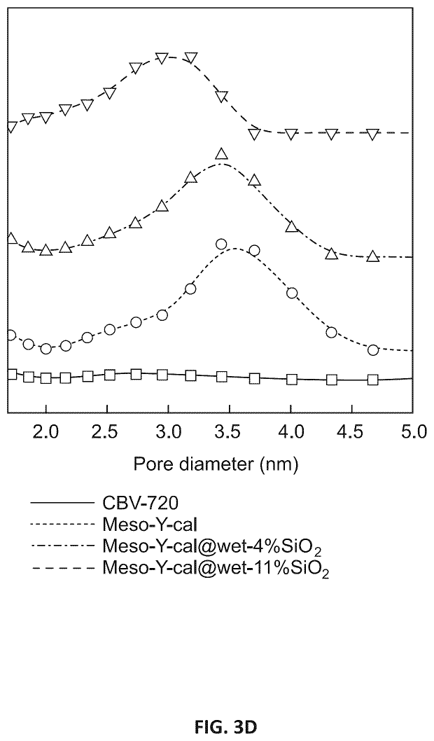

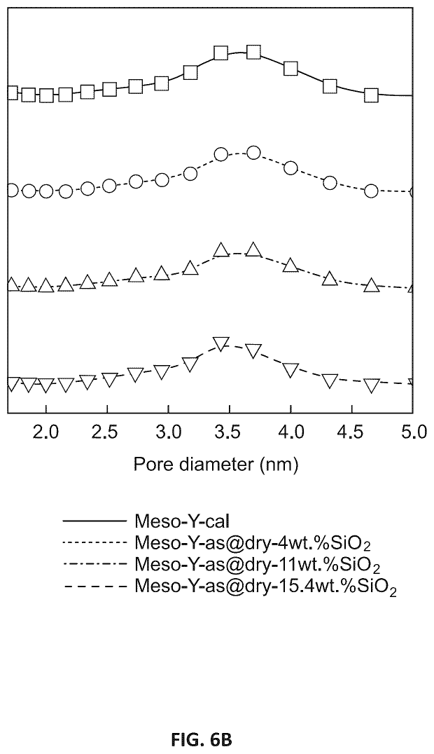

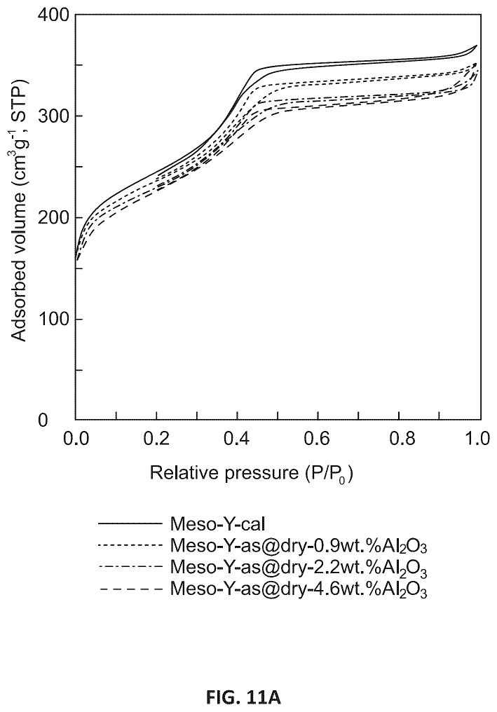

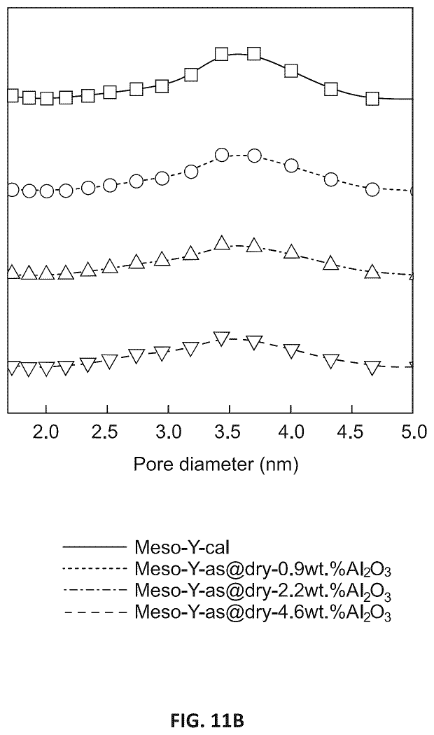

Powder X-ray diffraction patterns (PXRD) were collected using a Bruker D8 Advance diffractometer equipped with a Cu Kα radiation source (λ=1.5418 Å, 40 kV, 40 mA). Scanning electron microscopy (SEM) images were captured with a Hitachi S-5000 microscope. N₂ adsorption isotherms were measured at 77 K, and the mesopore size distribution as shown in FIG. 3B; FIG. 3D; FIG. 6B; and FIG. 11B, was calculated by the BJH method using a Micrometrics ASAP 2020 instrument. Before measurement, the samples were preheated at 350° C. for 4 h under vacuum condition. Transmission electron microscopy (TEM) images were acquired with JEOL JEM 2010 microscope in low-dose mode operating at 200 kV accelerating voltage and equipped with a LaB6 electron gun. Samples were prepared by embedding and curing in an epoxy resin followed by cutting thin sections (˜30-50 nm) with a Leica EM UC7 ultramicrotome. The sections were floated on to 300 mesh Cu grids with a thin (20-30 nm) lacey carbon support film. Zeta potential measurements were performed using a Malvern Zetasizer Nano-Z (Malvern Instruments, Malvern, UK). Before measurement, the samples were dispersed 0.5 wt. % in deionized water. After 5 min of ultrasonic treatment, the measurements were carried out at room temperature for at least 5 times to calculate an average.

### Results and Discussion, Conclusions

The material first used as a starting point for subsequent postsynthetic surface modification was calcined mesoporous Y zeolite (Meso-Y-cal), which was synthesized from parent CBV-720 (ammonium form) based on a previously reported literature surfactant-templating approach. The porosity of the Meso-Y-cal material was characterized using N₂ physisorption at 77 K. The adsorption isotherm is shown in FIG. 3A and comprises a combination of Types I and IV isotherms, shown by micropore filling below a relative pressure of 0.1, and pore condensation in mesopores at higher relative pressures. The mesopore size deconvolution of the isotherm data in FIG. 3B exhibits a narrow size distribution centered around 3.6 nm, and further confirms the generation of uniform intracrystalline mesoporosity. As a result, compared with the parent material CBV-720, the Meso-Y-cal sample exhibited an enhanced total specific surface area (886 m² g⁻¹ versus 760 m² g⁻¹ for CBV-720), mesopore surface area (525 m² g⁻¹ versus 180 m² g⁻¹ for CBV-720) and mesopore volume (0.44 cm³ g⁻¹ versus 0.22 cm³ g⁻¹ for CBV-720), while the micropore surface area (362 m² g⁻¹ versus 580 m² g⁻¹ for CBV-720) and the micropore volume (0.14 cm³ g⁻¹ versus 0.23 cm³ g⁻¹ for CBV-720) decreased. These data suggest that mesoporosity was generated in Meso-Y-cal, along with a slight decrease in microporosity in CBV-720.

Under wet conditions, the subsequent postsynthetic surface modification can be considered as a two-step process. The first step involves mixing a monomer precursor to the oxide overlayer (i.e. Si(OEt)₄ for silica or Al(O-i-Pr)₃ for alumina) with the hierarchical Meso-Y-cal zeolite, under wet conditions (i.e. exposure to ambient air). During this process, the monomer precursor diffuses into the Meso-Y, imbibing into pores close to the external surface. It is believed that partial hydrolysis and condensation occurs during this initial mixing, and during the second step, subsequent calcination, the organic shell combusts in air to synthesize steam and hydrolyzed/condensed crosslinked inorganic oligomers, which lead to the formation of an inorganic overlayer close to the zeolite external surface.

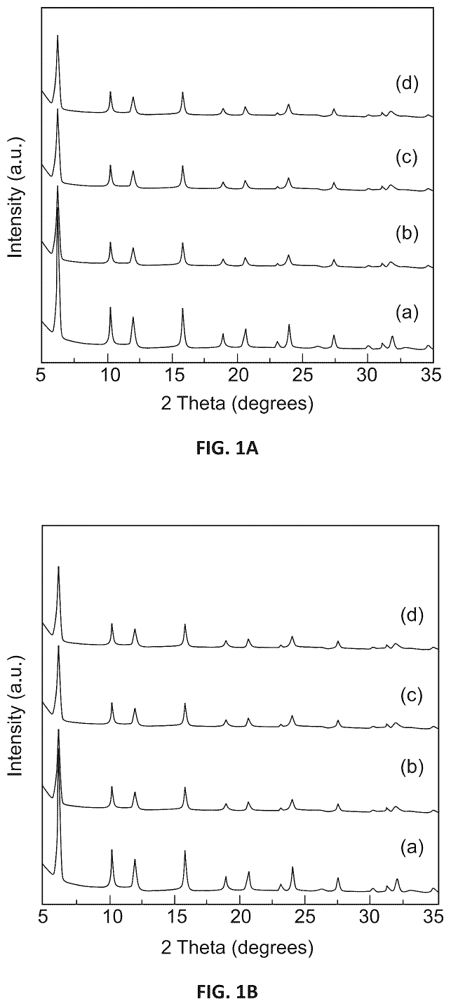

Under wet conditions, the as-made (Meso-Y-as) and calcined (Meso-Y-cal) samples were first silica coated, using 4 wt. % and 11 wt. % SiO₂ loaded onto the zeolite, prior to its calcination to SiO₂ in air. After SiO₂ overlayer deposition, both samples exhibited well-resolved PXRD patterns that are typical for FAU (FIG. 1A). The wet deposition condition had no significant negative impact on the zeolite crystalline structure. Similar observations are demonstrated in FIG. 1B for samples synthesized starting from Meso-Y-cal. These observations are similar to those reported previously when surface modifying HZSM-531 and SAPO-34 zeolites.

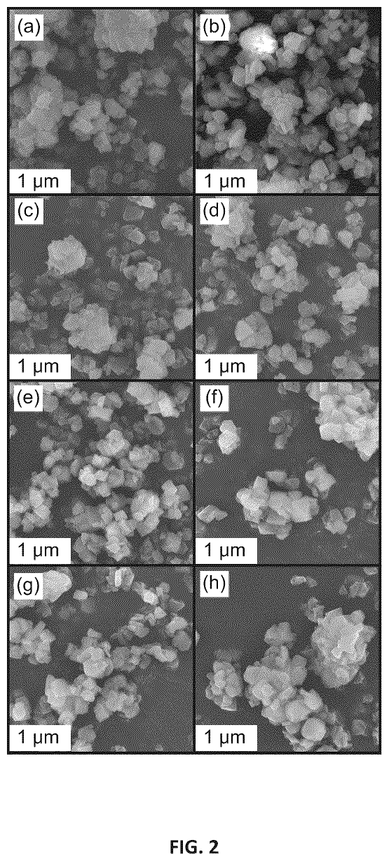

SEM images of the parent samples (Meso-Y-as and Meso-Y-cal) and the postsynthetically modified samples following SiO₂-overlayer deposition in FIG. 2 demonstrate no phase separation in all of the samples, as we observe a similar crystal morphology and size for CBV-720 and the resulting Meso-Y materials. A SiO₂-overlayer deposition must have occurred as a thin (nanoscale) shell either on the external surface of each crystallite or within the crystallite. It is impossible to tell these latter two possibilities apart with the SEM data (FIG. 2) alone, therefore, N₂ physisorption data were used.

Based on the N₂ physisorption isotherms in FIG. 3A, and the calculated porosity data in Table 1 below, the deposition of 4 wt. % SiO₂ on the Meso-Y-cal under wet conditions caused the mesopore surface area and volume to decrease (by about 12%), while the microporosity of Meso-Y-cal was retained (Table 1, No. 3). At 11 wt. % SiO₂ loading on Meso-Y-cal, the resulting material showed a significantly decreased micropore and mesopore surface area (by about 20%) and pore volume (by about 14%-36%) (Table 1, No. 4). With this increased amount of SiO₂, it appears the deposition process not only occurred at the mesopore surface of Meso-Y-cal, but it also causes partial interior micropore blockage. This result reveals that the open structure of the hierarchical Meso-Y-cal provides a large mesoporous surface area for silica-overlayer deposition, which interact with surface silanols in zeolite mesopores throughout the crystal during calcination, ultimately leading to the blockage of micropores and mesopores, particularly at the high SiO₂ loading of 11 wt. % under wet conditions.

TABLE 1
The coating parameters and porosity property of the parent CBV-
720, Meso- Y-cal and the resulting core-shell meso-Y catalysts.

| | | | | | Micropore | Mesopore | Total | | |
|---|---|---|---|---|---|---|---|---|---|
| | | SiO₂ | Al₂O₃ | Surface | surface | surface | pore | Micropore | Mesopore |
| | | loading | loading | area ^{a} | area | area ^{b} | volume ^{c} | volume ^{b} | volume |
| No. | Sample | (wt. %) | (wt. %) | (m² g⁻¹) | (m² g⁻¹) | (m² g⁻¹) | (cm³ g⁻¹) | (cm³ g⁻¹) | (cm³ g⁻¹) |
| 1 | CBV-720 | — | — | 760 | 580 | 180 | 0.45 | 0.23 | 0.22 |
| 2 | Meso-Y-cal | — | — | 886 | 362 | 525 | 0.58 | 0.14 | 0.44 |
| 3 | Meso-Y- | 4 | 0 | 822 | 367 | 456 | 0.54 | 0.15 | 0.39 |
| | cal@wet-4 | | | | | | | | |
| | wt. % SiO₂ | | | | | | | | |
| 4 | Meso-Y- | 11 | 0 | 703 | 293 | 410 | 0.40 | 0.12 | 0.28 |
| | cal@wet-11 | | | | | | | | |
| | wt. % SiO₂ | | | | | | | | |
| 5 | Meso-Y-as@wet- | 4 | 0 | 889 | 352 | 537 | 0.58 | 0.15 | 0.43 |
| | 4 wt. % SiO₂ | | | | | | | | |
| 6 | Meso-Y-as@wet- | 11 | 0 | 868 | 352 | 516 | 0.49 | 0.15 | 0.34 |
| | 11 wt. % SiO₂ | | | | | | | | |
| 7 | Meso-Y-as@wet- | 0 | 0.9 | 875 | 360 | 515 | 0.61 | 0.14 | 0.47 |
| | 0.9 wt. % Al₂O₃ | | | | | | | | |
| 8 | Meso-Y-as@wet- | 0 | 2.2 | 854 | 357 | 497 | 0.63 | 0.15 | 0.48 |
| | 2.2 wt. % Al₂O₃ | | | | | | | | |
| 9 | Meso-Y-as@wet- | 0 | 4.6 | 851 | 350 | 501 | 0.64 | 0.14 | 0.50 |
| | 4.6 wt. % Al₂O₃ | | | | | | | | |

^{a} Surface area was calculated by BET-plot.
^{b} Micropore volume and mesoporous surface area were calculated by t- plot method.
^{c} Total pore volume was calculated at P/P0 = 0.98.

The Meso-Y-as rather than calcined Meso-Y-cal material was investigated as a support for silica surface modification under wet conditions. N₂ physisorption data in FIG. 3C and Table 1 (No. 6) demonstrate the same material comprising an 11 wt. % SiO₂ overlayer on Meso-Y-as, when compared with the parent Meso-Y-cal (Table 1, No. 2). This same amount of microporosity in the coated material comprising 11 wt. % SiO₂ overlayer on Meso-Y-as is in stark contrast to the decreased microporosity observed when silica coating Meso-Y-cal. Also, consistent with this trend, a lower decrease in mesopore volume of 23% was observed, when applying the 11 wt. % SiO₂ overlayer to the Meso-Y-as material (vs 36% for the corresponding material starting with the Meso-Y-cal material). Moreover, the deposition of 11 wt. % SiO₂ on Meso-Y-as causes the mesopore size distribution to become more narrowed, as shown by data in FIG. 3D, whereas data in FIG. 3B demonstrate that deposition of the same amount of SiO₂ on Meso-Y-cal did not alter the mesopore size distribution. This different influence of the postsynthetic silica surface modification on the mesopore size distribution suggests that the deposition of the SiO₂ overlayer occurs at different locations when using either Meso-Y-as or Meso-Y-cal as a support material, favoring plugging of micropores in the latter.

The Meso-Y-as sample comprises CTAB surfactant in the mesopores, while the corresponding calcined-form Meso-Y-cal consists of an open hierarchically porous channel system (organic surfactant component was removed prior during calcination). It appears the surfactant CTAB plays an important role as a soft template in protecting interior microporosity from surface modification, based on the lack of micropore blockage in the 11 wt. % SiO₂ overlayer material when coating is performed on Meso-Y-as. This template guides the deposition of the silica overlayer in Meso-Y-as to occur only on mesopores rather than micropores. This suggests that the initial stage of calcination of silica surface-modified Meso-Y-as (i.e., after reaction with TEOS under wet conditions) causes partial decomposition of CTAB surfactant and creates space for silica deposition on the intracrystalline mesopore surface. During surfactant combustion, the partially decomposed CTAB surfactants can organize the formation of silica oligomers at the organic/inorganic interface through electrostatic interactions between positively charged CTAB and negatively charged silica species. This interaction would be expected to direct the deposition of the SiO₂ overlayer selectively, as observed, on the mesopore surface. During this process, owing to mesopore blockage by fragments of the CTAB surfactant, the silica oligomers would hardly penetrate into the micropore channel system of Meso-Y-as during calcination. However, spatially selective surface-modification approach benefits from the presence of surfactant CTAB in the mesopores, and is reminiscent of explanations of selective silylation of as-synthesized mesoporous silica MCM-41, when using organosilane. This condensed organosilane was found mainly grafted at the external surface of as-synthesized materials due to the soft protection afforded by the CTAB. It is also reminiscent of the protective effect that CTAB is known to offer zeolite Y under basic aqueous conditions, where the surfactant protects the zeolite from dissolution, due to strong interactions with the framework. Based on this observed protecting role of the microporosity conferred to by CTAB during silica deposition under wet conditions above, below the focus is on Meso-Y-as rather than Meso-Y-cal as the optimal starting material for inorganic-oxide overlayer deposition.

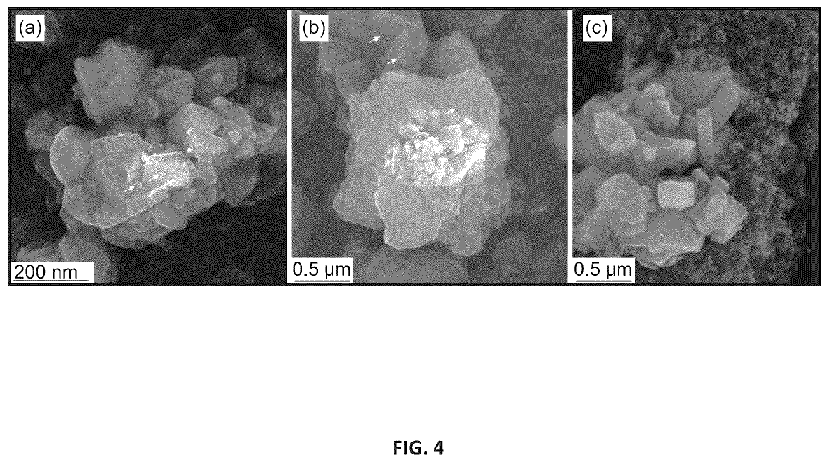

Surface modification with an alumina overlayer was also investigated under wet conditions, starting with the Meso-Y-as material. The resulting samples Meso-Y-as@wet-0.9 wt. % Al₂O₃, Meso-Y-as@wet-2.2 wt. % Al₂O₃, and Meso-Y-as@wet-4.6 wt. % Al₂O₃ exhibited nearly identical XRD patterns to the parent Meso-Y-as sample (FIG. 1A). The three coated samples also exhibited comparable microporosity and mesoporosity based on the N₂ adsorption data (Table 1, No. 7-9). However, SEM images in FIG. 4 show some small particles on the crystal surface of Meso-Y-as@wet-0.9 wt. % Al₂O₃ and Meso-Y-as@wet-2.2 wt. % Al₂O₃ (see 4a and 4b), with the quantity of such particles directly related to the amount of Al₂O₃ surface modification, for the Meso-Y-as@wet-4.6 wt. % Al₂O₃ sample (see 4c). It appears that alumina nanoparticles are formed on the external zeolite surface when performing surface modification of Al₂O₃ under wet conditions, via Al(O-i-Pr)₃ hydrolysis and condensation upon exposure to atmospheric moisture. The condensation product ultimately results in the mixture of Meso-Y and alumina nanoparticles on the zeolite external surface, and provides an approach for synthesizing a separate phase of alumina on the Meso-Y external surface, in which interfacial contact between the alumina and zeolite are minimized. This may prove useful in controlling this degree of contact or nanoscale intimacy for catalyst synthesis.

The above deposition experiments indicate that a wet condition could work for the silica shell deposition on the Meso-Y-as with CTAB surfactant only at a low SiO₂ loading (4 wt. %), in order to synthesize a material without severe micropore and mesopore blockage. At the high SiO₂ loading of 11 wt. %, a wet condition led to a material with decreased mesopore volume and mesopore size. Moreover, the wet condition led to a separate alumina phase, which did not have good interfacial contact with the zeolite.

These inconsistent results are frustrating, thus the present process was developed as a more general and effective synthetic method for more uniformly (homogeneously) modifying the crystal surface of Meso-Y, in a way that leads to a high degree of interfacial contact between the zeolitic material and overlayer, without formation of a separate external-surface amorphous phase, and in which both mesoporosity and microporosity of the Meso-Y zeolitic material could be preserved after modification. For silica deposition, the residual moisture in the wet deposition system appeared to induce the partial hydrolysis of TEOS, and catalyze condensation between surface silanols and partially hydrolyzed silica species even before calcination. This would cause an inhomogeneous distribution of silica species favoring areas close to the external surface, and lead to mesopore size narrowing during calcination.

The present surface modification process, however, is conducted under rigorously dry conditions. Residual water can be removed, e.g., under vacuum, by heating the Meso-Y-as material at a temperature of 250° C., and conducting the deposition under air-free conditions, prior to the next step of calcination in either ambient air or dry air.

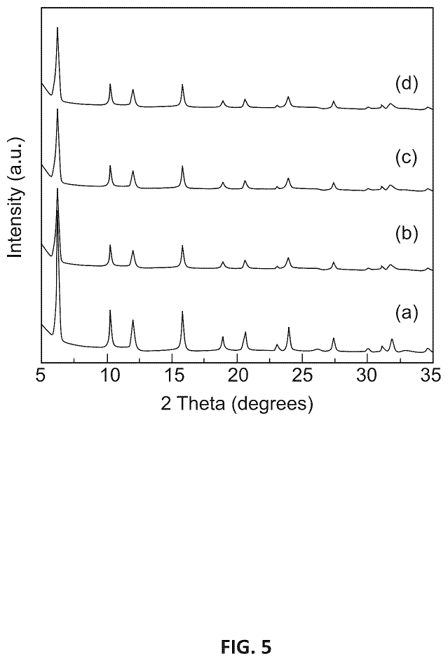

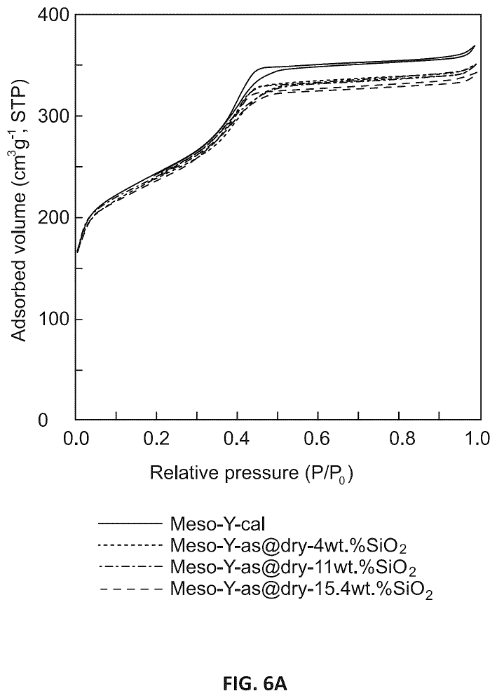

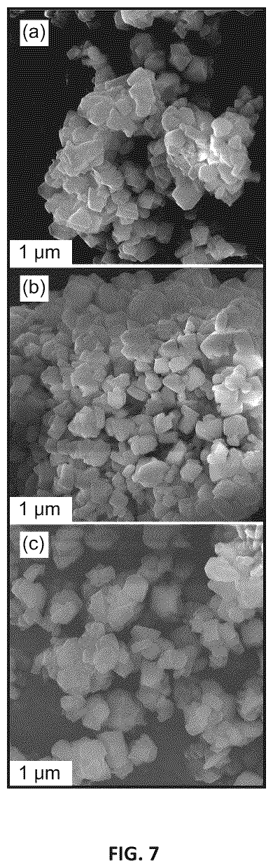

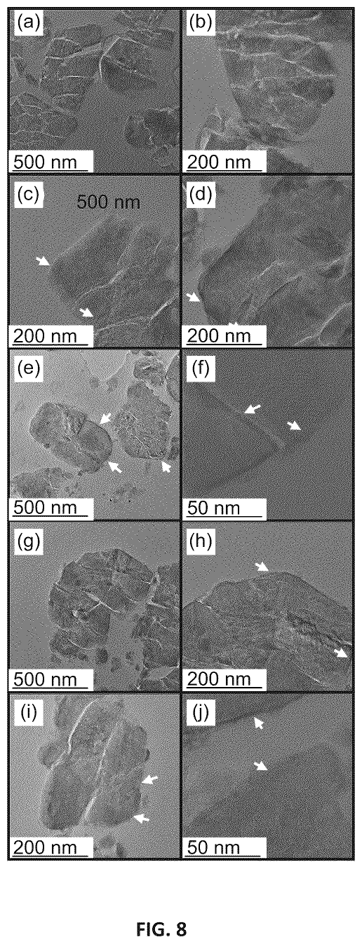

As shown in FIG. 5, the silica overlayer deposition on the as-synthesized Meso-Y-as under dry conditions produced materials with a high degree of crystallinity, as in the parent mesoporous zeolite Y. In addition, the N₂ adsorption-desorption isotherms (FIG. 6A) and the corresponding calculated surface area and pore volume of the obtained calcined samples with SiO₂ loadings from 4-15.4 wt. % (Table 2 below, No. 3-5) indicated the micropores of the parent Meso-Y sample were still open, without any evidence of pore blockage. This latter result is similar to what was observed under wet conditions, yet in contrast to silica-surface modification under wet conditions (FIG. 3D), the mesopore size of the silica-coated materials was maintained after SiO₂ deposition under dry conditions (FIG. 6B). The slightly decreased mesopore surface area in the surface-modified samples is a consequence of silica deposition on the external surface, resulting in limited blocking of the entrance to a few of the mesopores throughout the crystal (Table 2, No. 3-5). However, any such silica overlayer on the external surface was thin, because no separate phase could be observed in these two samples from the SEM images (FIG. 7). TEM images in FIG. 8 demonstrate the thinness (less than 10 nm) of the silica overlayer on the Meso-Y zeolite external surface. The silica deposition under dry conditions could be performed successfully on the Meso-Y-as material even at a high SiO₂ loading of 15.4 wt. % without micropore blockage and with limited mesopore blockage (Table 2, No. 5). This low amount of pore blockage could not be achieved under wet silica deposition conditions. Under dry conditions, during calcination, the introduced silica source, TEOS, interacted with the partially decomposed surfactant CTAB in the intracrystalline mesopores, and formed a much more homogeneous silica overlayer at the mesopore surface of Meso-Y-as.

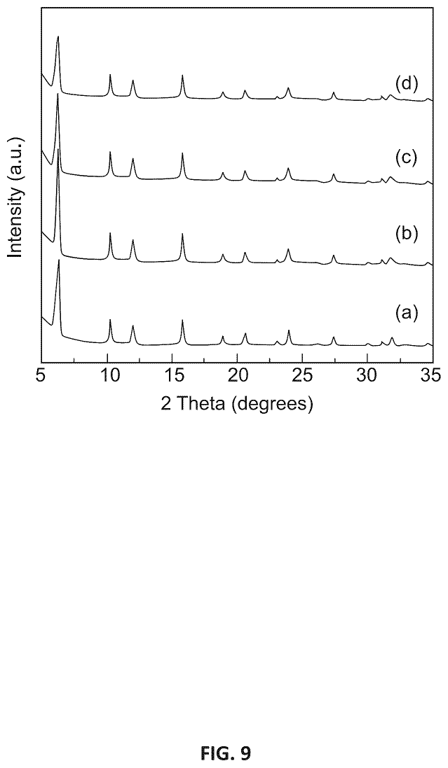

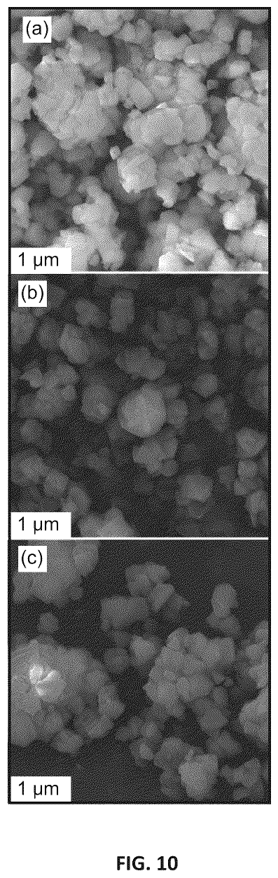

The investigation of alumina surface modification of the Meso-Y-as material under dry conditions, using Al(O-i-Pr)₃ as the precursor provided interesting results. Based on the PXRD patterns shown in FIG. 9, after synthesis of a 0.9-4.6 wt. % Al₂O₃ overlayer, the resulting samples retained a highly crystalline FAU framework structure. However, in stark contrast to results that were obtained under wet conditions in FIG. 4, SEM data in FIG. 10 demonstrate that no other phase was observed and the crystal preserved its morphology, following alumina surface modification under dry conditions. TEM images in FIG. 8(g-j) show a thin (less than 10 nm) alumina overlayer on the external surface of the Meso-Y zeolitic material. The dry condition gave rise to a homogeneous alumina coating, with a high degree of interfacial contact between the alumina and zeolitic material. Under dry conditions, the hydrolysis of the Al source caused by the presence of residual water was completely avoided, resulting in Al(O-i-Pr)₃ grafting only at the external surface of the parent zeolite sample. Furthermore, based on the N₂ adsorption-desorption data (FIG. 11A), it could be observed that the micropores were not affected by the Al₂O₃ surface modification at low Al₂O₃ loadings of 0.9-2.2 wt. %, as the obtained samples showed comparable micropore surface areas and micropore volumes as the parent Meso-Y-cal (FIG. 11B; Table 2 below, No. 6-7).

TABLE 2
The coating parameters and porosity property of the parent CBV-720, calcined meso-Y
and the resulting core-shell meso-Y catalysts, which was calcined in air.

| | | | | | Micropore | Mesopore | Total | | |
|---|---|---|---|---|---|---|---|---|---|
| | | SiO₂ | Al₂O₃ | Surface | surface | surface | pore | Micropore | Mesopore |
| | | loading | loading | area ^{a} | area | area ^{b} | volume ^{c} | volume ^{b} | volume |
| No. | Sample | (wt. %) | (wt. %) | (m² g⁻¹) | (m² g⁻¹) | (m² g⁻¹) | (cm³ g⁻¹) | (cm³ g⁻¹) | (cm³ g⁻¹) |
| 1 | CBV-720 | — | — | 760 | 580 | 180 | 0.45 | 0.23 | 0.22 |
| 2 | Meso-Y-cal | — | — | 886 | 362 | 525 | 0.58 | 0.14 | 0.44 |
| 3 | Meso-Y- | 4 | 0 | 865 | 382 | 483 | 0.57 | 0.16 | 0.41 |
| | as@dry-4 | | | | | | | | |
| | wt. % SiO₂ | | | | | | | | |
| 4 | Meso-Y- | 11 | 0 | 878 | 387 | 491 | 0.56 | 0.16 | 0.40 |
| | as@dry-11 | | | | | | | | |
| | wt. % SiO₂ | | | | | | | | |
| 5 | Meso-Y- | 15.4 | 0 | 863 | 372 | 491 | 0.54 | 0.15 | 0.39 |
| | as@dry-15.4 | | | | | | | | |
| | wt. % SiO₂ | | | | | | | | |
| 6 | Meso-Y- | 0 | 0.9 | 860 | 378 | 482 | 0.58 | 0.14 | 0.44 |
| | as@dry-0.9 | | | | | | | | |
| | wt. % Al₂O₃ | | | | | | | | |
| 7 | Meso-Y- | 0 | 2.2 | 836 | 356 | 480 | 0.55 | 0.15 | 0.40 |
| | as@dry-2.2 | | | | | | | | |
| | wt. % Al₂O₃ | | | | | | | | |
| 8 | Meso-Y- | 0 | 4.6 | 790 | 318 | 472 | 0.55 | 0.12 | 0.42 |
| | as@dry-4.6 | | | | | | | | |
| | wt. % Al₂O₃ | | | | | | | | |

^{a} Surface area was calculated by BET-plot.
^{b} Micropore volume and mesoporous surface area were calculated by t-plot method.
^{c} Total pore volume was calculated at P/P0 = 0.98

At a relatively high Al₂O₃ loading of 4.6 wt. %, slightly decreased micropore surface area (318 m² g⁻¹ versus 362 m² g⁻¹ for Meso-Y-cal) and micropore volume (0.12 cm³ g⁻¹ versus 0.14 cm³ g⁻¹ for Meso-Y-cal) were observed (Table 2, No. 8). In one embodiment, a limit (2.2 wt. % Al₂O₃) for the alumina coating on the Meso-Y surface under dry conditions is preferred, to avoid micropore blockage.

Rigorously dried air was also used to calcine the intermediate sample that was obtained after mixing the inorganic-oxide overlayer source (i.e. TEOS or Al(O-i-Pr)₃) with Meso-Y-as under dry conditions. The same near lack of change in terms of porosity after coating with a silica or alumina shell was observed in both dry and humid air. This result indicated that keeping the first step of mixing the deposited inorganic-oxide overlayer source with Meso-Y-as dry was more crucial than to keep the calcination step dry, in which steam is liberated in any case during combustion of organic. This steam causes hydrolysis and condensation between the inorganic shell and silanols on the zeolite surface.

Given the lack of phase separation observed between the silica/alumina overcoats and the Meso-Y-cal support as evidenced by SEM in FIGS. 7 and 10, as well as the intimate interfacial contact between the overcoats and the support in the TEM images in FIG. 8, one must conclude that the present synthesis approach under dry conditions uniformly leads to nanoscale overlayers of silica/alumina on the Meso-Y-cal support.

How such nanoscale overlayers affect the Zeta-potential (or surface charge) of the surface-modified Meso-Y-cal support was also investigated. To address this, the Zeta-potential of all of materials synthesized under dry conditions at pH=7 in deionized water were measured. The Zeta-potential is known to directly reflect the degree of surface hydroxyl group protonation/dissociation, which is controlled by the surface Si/Al compositions. These data are shown Table 3 below.

Table 3. Zeta-potential measurements of the Meso-Y-cal and the resulting core-shell meso-Y catalysts, which was calcined in air.
Material Zeta-potential (mV)
Meso-Y-cal −39.3±0.3
Meso-Y-as@dry-4 wt. % SiO₂ −40.6±0.5
Meso-Y-as@dry-11 wt. % SiO₂ −41.2±0.3
Meso-Y-as@dry-15.4 wt. % SiO₂ −41.6±0.3
Meso-Y-as@dry-0.9 wt. % Al₂O₃ −37.3±0.6
Meso-Y-as@dry-2.2 wt. % Al₂O₃ −36.0±0.4
Meso-Y-as@dry-4.6 wt. % Al₂O₃−32.0±0.5

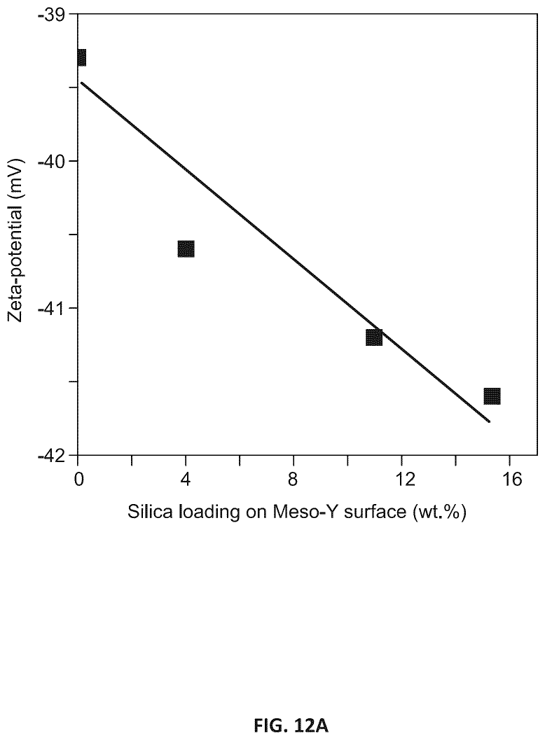

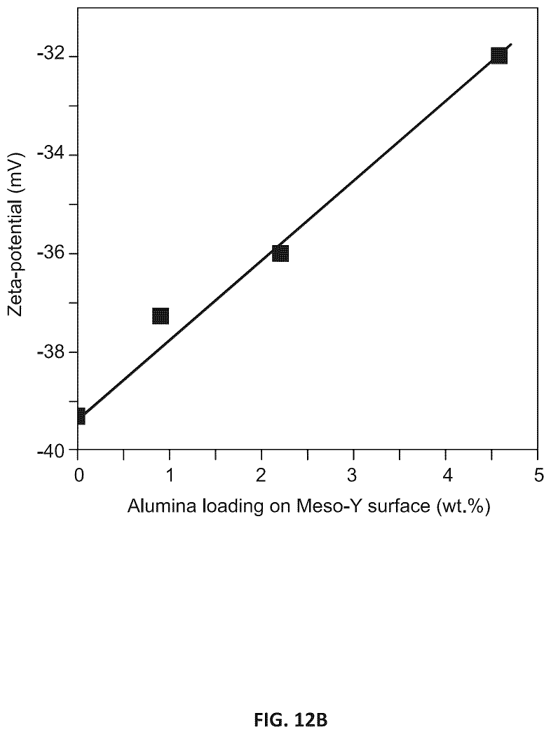

The uncoated calcined Meso-Y-cal zeolite had a negatively charged surface corresponding to a Zeta-potential of −39.3 mV. After silica surface modification, the Zeta-potential of the coated materials became more negative with increasing amount of silica overlayer, consistent with a greater dissociation of surface hydroxyl groups in silica compared with Meso-Y-cal. In contrast, alumina surface modification increased the Zeta-potential of the coated materials, in a manner that directly depended on the amount of alumina overlayer, as shown by data in Table 3. The linear progression of the Zeta potential with amount of silica/alumina overcoat is shown in FIGS. 12A and 12B. This linearity is consistent with the previously mentioned uniform lack of phase separation at all compositions. That is to say, if there was an onset of phase separation of silica/alumina at a certain high loading, this would be manifested as nonlinearity in FIG. 12, which is not observed. It is noted that alumina in general possesses a more positive Zeta-potentials relative to silica at pH=7.

Because of the observed uniformity of the silica/alumina as nanoscale overlayers on top of the Meso-Y-cal support rather than phase-separated oxide particles away from it, as observed here with SEM/TEM microscopy imaging as well as supported by Zeta-potential measurements, the synthetic approach described herein under dry conditions will be a useful method for controlling the surface charge of Meso-Y-cal zeolitic material in a rational fashion—all while avoiding pore plugging. This synthetic control has clear applications for the nucleation of single and bimetallic metal clusters on the zeolite surface using approaches such as strong-electrostatic adsorption, as well as controlling the dispersability of Meso-Y-cal particles during catalyst shaping, which involves concentrated aqueous suspensions and a general desire to avoid aggregation of zeolite particles to themselves.

Based on the results above, a mixed aluminosilicate coating was also synthesized on the Meso-Y-as—one that comprises both silica and alumina components together in the overcoat, rather than an overcoat based only on either silica or alumina in the shell, as in the previous examples above. The advantages to such an aluminosilicate shell are inclusion of a catalytically active overlayer, because of it possessing Al—O—Si sites, which are known to be active for acid catalysis. The approach used dry conditions. Using this approach, the surface was modified with both silica (i.e. TEOS) and alumina (i.e. Al(O-i-Pr)₃) precursors simultaneously, to synthesize a coating with average silica-to-alumina ratios (SAR) ranging from 14 to 150, both at 4 wt. % and 8 wt. % (weight percentages refer to total amount of SiO₂ and Al₂O₃). The data shows the zeolite products after aluminosilicate surface modification possessed comparable microporosity (e.g., the micropore volume) compared with the calcined parent material Meso-Y-cal. These data support the conclusions above regarding pure silica and alumina coatings, by confirming that the aluminosilicate surface modification process also did not cause the blockage of zeolite pores. The uniformity of the aluminosilicate coatings was also verified by SEM and TEM (aluminosilicate layer is below 30 nm thickness). As in the case of the pure silica and alumina surface modification, the Zeta potential of the aluminosilicate modified materials was measured, and the data show the Zeta potentials to be significantly less negative than the parent Meso-Y-cal material, in a manner that sensitively depended on the silicon-to-alumina ratio of the coating.

Given the propensity for using inorganic-oxide surface modified zeolites in functional applications, the resulting surface modified Meso-Y zeolite materials are a promising new type of zeolitic material for functional applications involving adsorption and catalysis, in which the surface charge (zeta potential) of the surface can be controlled.

As used in this disclosure the word “comprises” or “comprising” is intended as an open-ended transition meaning the inclusion of the named elements, but not necessarily excluding other unnamed elements. The phrase “consists essentially of” or “consisting essentially of” is intended to mean the exclusion of other elements of any essential significance to the composition. The phrase “consisting of” or “consists of” is intended as a transition meaning the exclusion of all but the recited elements with the exception of only minor traces of impurities.

All patents and publications referenced herein are hereby incorporated by reference to the extent not inconsistent herewith. It will be understood that certain of the above-described structures, functions, and operations of the above-described embodiments are not necessary to practice the present invention and are included in the description simply for completeness of an exemplary embodiment or embodiments. In addition, it will be understood that specific structures, functions, and operations set forth in the above-described referenced patents and publications can be practiced in conjunction with the present invention, but they are not essential to its practice. It is therefore to be understood that the invention may be practiced otherwise that as specifically described without actually departing from the spirit and scope of the present invention as defined by the appended claims.

What is claimed is:

1. A process for depositing a silica, alumina, or aluminosilicate layer on a Meso-Y zeolite comprising:
(a) dehydrating a Meso-Y zeolite comprising CTAB surfactant inside its mesopores;
(b) mixing alumina, silica, or aluminosilicate precursors with a dry solvent to create a mixture;
(c) inserting the dehydrated Meso-Y zeolite from (a) into a reactor with a dry atmosphere, and inserting the mixture from (b) into the same reactor;
(d) refluxing the contents of the reactor to achieve a deposition reaction creating a layer of alumina, silica, or aluminosilicate on the surface of the Meso-Y zeolite; and
(e) recovering Meso-Y-as zeolite product from the reactor.

2. The process of claim 1 wherein, after recovering the Meso-Y-as zeolite from the reactor, solvent is removed from the zeolite.

3. The process of claim 2, wherein the solvent is removed by evacuation.

4. The process of claim 2, further comprising calcining the Meso-Y-as zeolite after removal of the solvent.

5. The process of claim 2, wherein the zeolite is dried after removal of the solvent.

6. The process of claim 5, wherein the drying is under vacuum.

7. The process of claim 5, wherein the dried zeolite is calcined.

8. The process of claim 7, wherein the calcining is in dry air.

9. The process of claim 1, wherein the refluxing occurs with stirring.

10. The process of claim 1, wherein an alumina precursor is mixed in (b).

11. The process of claim 1, wherein a silica precursor is mixed in (b).

12. The process of claim 1, wherein silica and alumina precursors to effect an aluminosilicate layer on the surface of the Meso-Y zeolite are mixed in (b).

13. The process of claim 1, wherein dry tetrahydrofuran (THF) is the dry solvent.

14. The process of claim 1, wherein the dry atmosphere in the reactor comprises an inert gas.

15. The process of claim 1, wherein the dry atmosphere in the reactor is comprised of nitrogen gas.

16. The process of claim 1, wherein the dehydrating of the Meso-Y zeolite in (a) comprises heating under vacuum.

17. The process of claim 16, wherein the heating under vacuum comprises heating at 250° C. under vacuum for 10 hours.

18. The process of claim 1, wherein the deposition reaction in (d) is carried out under dry N₂ atmosphere under reflux and stirring for 1 hour.

19. The process of claim 5, wherein the drying occurs at 120° C. for 2 hours under vacuum.

20. The process of claim 1, wherein the solution mixture in (b) is filtered under air-free condition to remove any undissolved solids.

21. The process of claim 1, wherein the Meso-Y zeolite comprises CBV-720.

22. The process of claim 1, wherein the silica precursor comprises Si(OEt)₄.

23. The process of claim 7, wherein the alumina precursor comprises Al(O-i-Pr)₃.
